(19) United States
(12) Patent Application Publication
(10) Pub. No.: US 2023/0246929 A1
(43) Pub. Date: Aug. 3, 2023

(54) PACKET COLLECTION SYSTEM, PACKET INTEGRATION ANALYSIS APPARATUS, PACKET COLLECTION METHOD AND PROGRAM

(71) Applicant: NIPPON TELEGRAPH AND TELEPHONE CORPORATION, Tokyo (JP)

(72) Inventors: Masahiro SHIRAISHI, Tokyo (JP); Hiroki NAGAYAMA, Tokyo (JP); Keiichi OKABE, Tokyo (JP); Tomoaki WASHIO, Tokyo (JP); Asami MIYAJIMA, Tokyo (JP)

(21) Appl. No.: 18/001,506

(22) PCT Filed: Jun. 15, 2020
(86) PCT No.: PCT/JP2020/023479

§ 371 Date: Dec. 12, 2022

(51) Int. Cl. H04L 43/04; H04L 43/028

(52) U.S. Cl. CPC H04L 43/04; H04L 43/028

(57) ABSTRACT

A packet collection system for collecting a packet for abnormality detection in a communication system including segments in which a packet having an encrypted payload is transmitted and received. The packet collection system includes a header collection device to collect the packet in the communication system from each segment in chronological order and store header information and payload information of the packet collected; a payload collection device provided in each segment, to decrypt the payload information in the packet received in the segment and store decrypted payload information along with the header information and the payload information; and a packet integration analysis apparatus to acquire and store the header, payload, and decrypted payload information aligned in chronological order by matching the header and payload information in chronological order received from the header collection device with the header, payload, and decrypted payload information received from the payload collection device.

### TECHNICAL FIELD

The present disclosure relates to a technique for collecting an abnormality detection packet in secure multicast communication.

### BACKGROUND ART

Industrial systems sometimes uses encrypted communication to prevent interception or falsification of confidential control parameters and the like distributed on a network (NW).

Unfortunately, the use of encrypted communication still leaves a risk of a cyberattack via communication or the like including a control parameter that causes an unauthorized operation when an encryption key is stolen, and leaves a risk of a cyberattack via communication reusing a record of communication previously distributed (Replay) even when no encryption key is stolen.

### CITATION LIST

### Non Patent Literature

NPL 1: SSL accelerator, Hitachi Solutions, [https://www.hitachi-solutions.co.jp/array/sp/apv/function2.html]

### SUMMARY OF THE INVENTION

### Technical Problem

To detect the cyberattack as an abnormality on the NW, analyzing, for example, a change amount over time of a value of data to be transmitted and received is awaited. Accordingly, data collection for analyzing, in chronological order, a plurality of pieces of data (decrypted data) to be transmitted and received is awaited.

Regarding abnormality detection, NPL 1 discloses a dedicated device that performs communication encryption and decryption, and abnormality detection processing for a system requiring a high throughput similar to the industrial systems.

Unfortunately, the related art including the technique disclosed in NPL 1 cannot achieve efficient data collection for analyzing a plurality of pieces of decrypted data in chronological order.

The present disclosure has been made in view of the above points, and an object of the present disclosure is to provide a technique capable of efficient data collection for analyzing a plurality of pieces of decrypted data in chronological order in a communication system in which encrypted communication is performed.

### Means for Solving the Problem

The disclosed technique provides a packet collection system for collecting a packet for abnormality detection in a communication system including one or more segments in which a packet having an encrypted payload is transmitted and received. The packet collection system includes a header collection device that collects the packet transmitted and received in the communication system from an individual segment of the one or more segments in chronological order and stores header information and payload information of the packet collected, a payload collection device that is provided in the individual segment in the communication system, decrypts the payload information in the packet received in the segment, and stores decrypted payload information along with header information and payload information of the packet received, and a packet integration analysis apparatus that acquires and stores the header information, the payload information, and the decrypted payload information aligned in chronological order by matching the header information and the payload information in chronological order received from the header collection device with the header information, the payload information, and the decrypted payload information received from the payload collection device.

### Effects of the Invention

The disclosed technique provides a technique capable of efficient data collection for analyzing a plurality of pieces of decrypted data in chronological order in a communication system in which encrypted communication is performed.

### BRIEF DESCRIPTION OF DRAWINGS

FIG. 1 is a diagram for illustrating a processing load of encrypted communication.

FIG. 2 is a diagram for illustrating an example of detection of unauthorized communication.

FIG. 3 is a diagram illustrating an example of a packet collection system.

FIG. 4 is a configuration diagram of a system according to an embodiment of the present disclosure.

FIG. 5 is a configuration diagram of the system in the embodiment of the present disclosure.

FIG. 6 is a diagram for illustrating a flow of a packet.

FIG. 7 is a diagram for illustrating a flow of a packet.

FIG. 8 is a configuration diagram of a header collection device.

FIG. 9 is a flowchart for describing an operation of the header collection device.

FIG. 10 is a diagram illustrating an image of a packet to be received.

FIG. 11 is a diagram illustrating an example of a table stored in a traffic data recording unit.

FIG. 12 is a configuration diagram of a payload collection unit.

FIG. 13 is a flowchart for describing an operation of the payload collection unit.

FIG. 14 is a diagram illustrating an example of a table stored in a payload data recording unit.

FIG. 15 is a diagram illustrating data transfer to a packet integration analysis apparatus.

FIG. 16 is a configuration diagram of the packet integration analysis apparatus.

FIG. 17 is a flowchart for describing an operation of the packet integration analysis apparatus.

FIG. 18 is a diagram for describing determination of an order of data.

FIG. 19 is a diagram illustrating an example of a table stored in a global traffic data recording unit.

FIG. 20 is a diagram for illustrating an example of a case of unicast.

FIG. 21 is a diagram illustrating an example of collected information.

FIG. 22 is a diagram illustrating an example of the collected information.

FIG. 23 illustrates a hardware configuration example of a device.

### DESCRIPTION OF EMBODIMENTS

Hereinafter, an embodiment of the present disclosure (the present embodiment) will be described with reference to the accompanying drawings. The embodiment to be described below is an example, and embodiments to which the present disclosure is applied are not limited to the following embodiment.

Problems Before an embodiment of the present disclosure is described in detail, possible problems of a packet collection system without the present disclosure will be described.

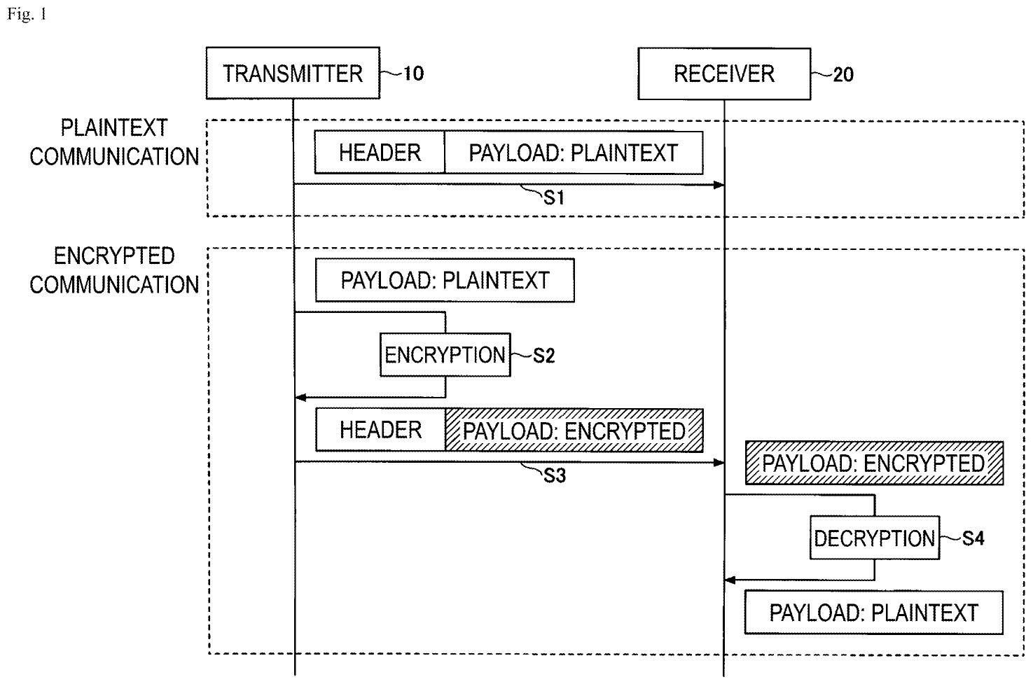

First, a processing load when encrypted communication is performed between a transmitter 10 and a receiver 20 will be described with reference to FIG. 1.

When plaintext communication is performed, the transmitter 10 transmits a packet including a header and a plaintext payload to the receiver 20 (S1). When encrypted communication is performed, the transmitter 10 first encrypts a plaintext payload (S2) and transmits a packet including the encrypted payload and a header (S3). In S4, the receiver 20 decrypts the encrypted payload to acquire a plaintext payload.

As described above, as compared to the plaintext communication, in the encrypted communication, the processing load increases by encryption and decryption processes.

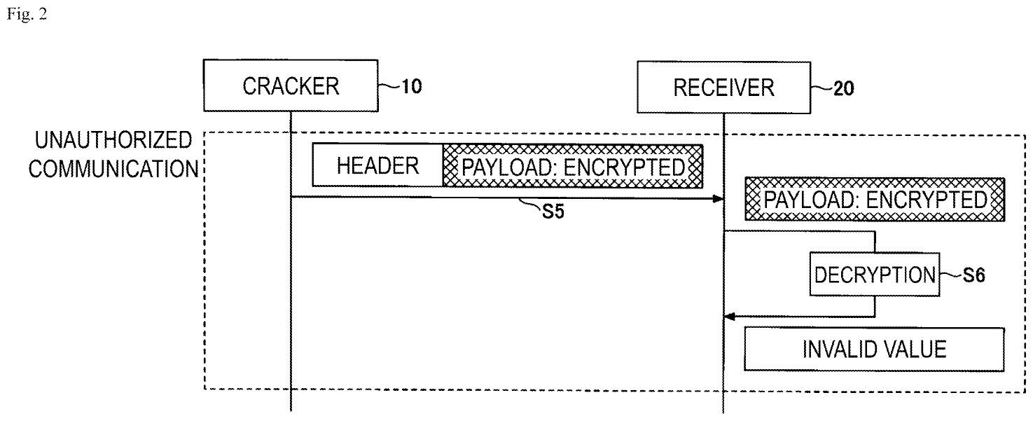

FIG. 2 illustrates a case where unauthorized communication is detected. Here, it is assumed that the transmitter 10 is an attacker (cracker 10). It is not possible to detect an invalid value unless the payload is decrypted. Thus, the receiver 20 receives a packet including the encrypted payload (S5) and decrypts the payload (S6) to detect the invalid value.

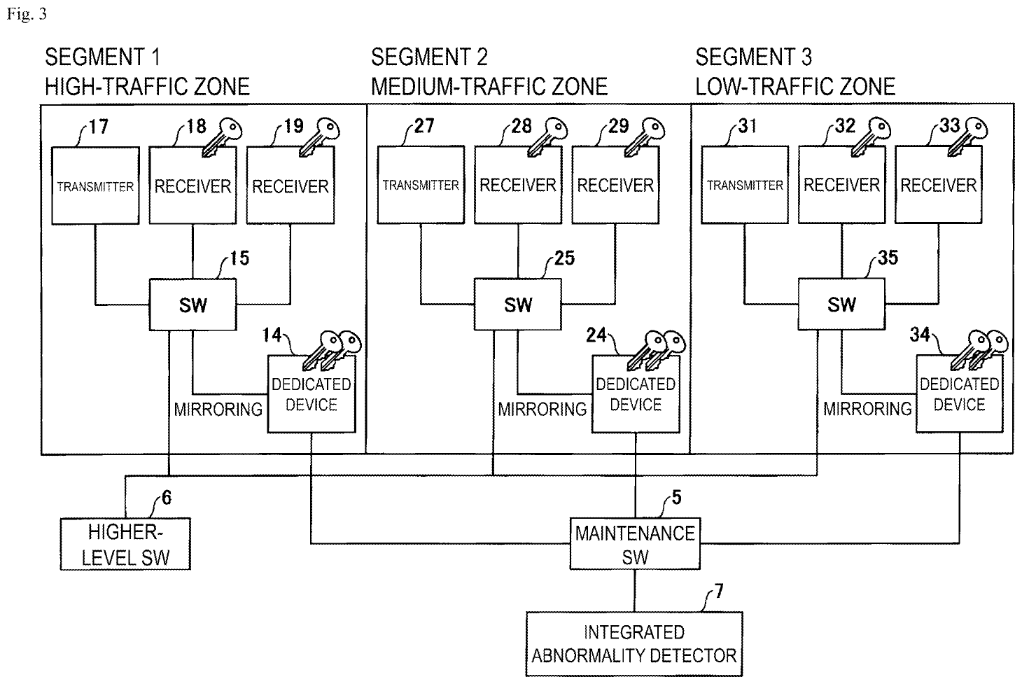

FIG. 3 is a diagram illustrating a configuration example of a system for collecting an abnormality detection packet by using a dedicated device (offload device) that offloads a processing load for detecting an abnormality. The system itself illustrated in FIG. 3 is not a technique in the related art. This is a configuration of a system assumed when a packet is collected by using the dedicated device being the technique in the related art.

The system in FIG. 3 is divided into three segments (for example, three multicast groups). The segment 1 is a high-traffic zone. The segment 2 is a medium-traffic-zone, and the segment 3 is a low-traffic zone. The segment 1 includes a transmitter 17, receivers 18 and 19, a switch (SW) 15, and a dedicated device 14. The segment 2 includes a transmitter 27, receivers 28 and 29, a switch (SW) 25, and a dedicated device 24. The segment 3 includes a transmitter 31, receivers 32 and 33, a switch (SW) 35, and a dedicated device 34.

The SWs 15, 25, and 35 are connected to a higher-level SW 6. The dedicated device in each segment is connected to a maintenance SW 5. The maintenance SW 15 is connected to an integrated abnormality detector 7.

The dedicated device in each segment receives, from the SW in the segment, a packet transmitted and received between the transmitter and the receiver in the segment, by mirroring. Then, the dedicated device decrypts an encrypted payload in the received packet and transmits a header and the decrypted payload to the integrated abnormality detector 7. The integrated abnormality detector 7 performs integrated abnormality detection by analyzing data received from each dedicated device.

Unfortunately, in the configuration illustrated in FIG. 3, it is necessary to set or create sharing of a key of the receiver with the dedicated device of each segment. Thus, a sharing server or the like is required, and an operation cost increases.

In addition, since the traffic load applied to the dedicated device is different for each segment, there is a problem that a data collection timing by the integrated abnormality detector 7 is not aligned.

Thus, the integrated abnormality detection device 7 needs to sort pieces of data in chronological order in order to analyze the pieces of data in chronological order. Unfortunately, since the data is collected one after another by the integrated abnormality detection device 7, there is a case where it is not possible to appropriately perform time-series data analysis even though time-series sorting is performed.

That is, when the dedicated device is introduced as in the above system, the operation efficiency of key management or the like is poor. In addition, data collected from a dedicated device (off-road machine) is poor in collection efficiency as abnormality detection data. That is, there is a problem that data collection is delayed depending on the traffic amount and the arrangement configuration of the offload device, and integration processing after data collection is required.

More specifically, with respect to the situation in which the data collection timing is not aligned, not only the processing of aligning the time series is performed, but also a function accompanied with a setting related to the accuracy of abnormality detection, such as processing of creating data for abnormality detection in which a certain time is divided and data that is not reached within the certain time is treated as missing or waiting until data is aligned, is required for integration processing.

The system according to the present embodiment described below solves the above problem, enabling efficient data collection for analyzing a plurality of pieces of decrypted data in chronological order in a communication system in which encrypted communication is performed.

That is, in the present embodiment, collection efficiency of the abnormality detection data is increased in a manner that a decryption processing function and a collection processing function are hierarchically arranged based on a transmission range of communication, and pieces of collected information are integrated later.

Specifically, in recent years, a device (payload collection device) that decrypts and collects a payload is disposed in a transmission range (multicast group) of secure multicast communication used in an industrial system, and further, a device (header collection device) that collects header information and the like in chronological order across a plurality of multicast groups and a device (packet integration analysis apparatus) that matches the decrypted payload with header data arranged in chronological order are disposed. Hereinafter, the technique according to the present embodiment will be described in more detail.

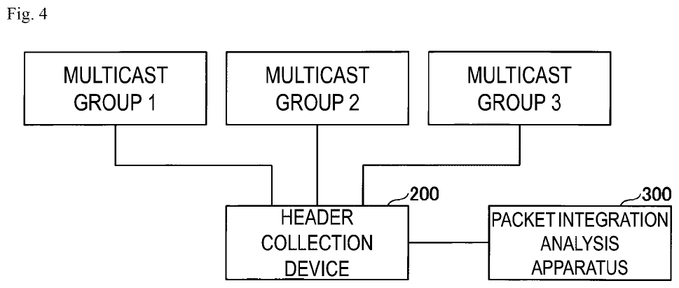

System Configuration FIG. 4 illustrates an overall configuration diagram of the packet collection system according to the embodiment of the present disclosure. As illustrated in FIG. 4, the packet collection system includes a multicast group 1, a multicast group 2, and a multicast group 3. Each multicast group is connected to a header collection device 200, and data can be transmitted and received between each multicast group and the header collection device 200. A packet integration analysis apparatus 300 is connected to the header collection device 200, and data can be transmitted and received between the packet integration analysis apparatus 300 and the header collection device 200.

The “multicast group” may be referred to as a “segment”. As will be described later, the technique according to the present embodiment is applicable not only to multicast communication but also to unicast communication. The “segment” may include both a meaning of “a range in which multicast communication is performed” and a meaning of “a range in which unicast communication is performed”.

A case where the three multicast groups are provided as illustrated in FIG. 4 is just an example. The number of multicast groups may be one, two, or four or more.

The types of the three multicast groups illustrated in FIG. 4 are not particularly limited. For example, similarly to the segments 1 to 3 illustrated in FIG. 3, it may be assumed that the multicast groups are divided into zones in accordance with the traffic amount. For example, zones as follows may be provided: a zone in which the multicast group 1 processes sensor data, a zone in which the multicast group 2 performs communicates for a controller, and a zone in which the multicast group 3 controls an actuator.

As described above, the specific types and the like of the devices included in the multicast group may be different among the multicast groups, but the basic configuration is the same among the multicast groups.

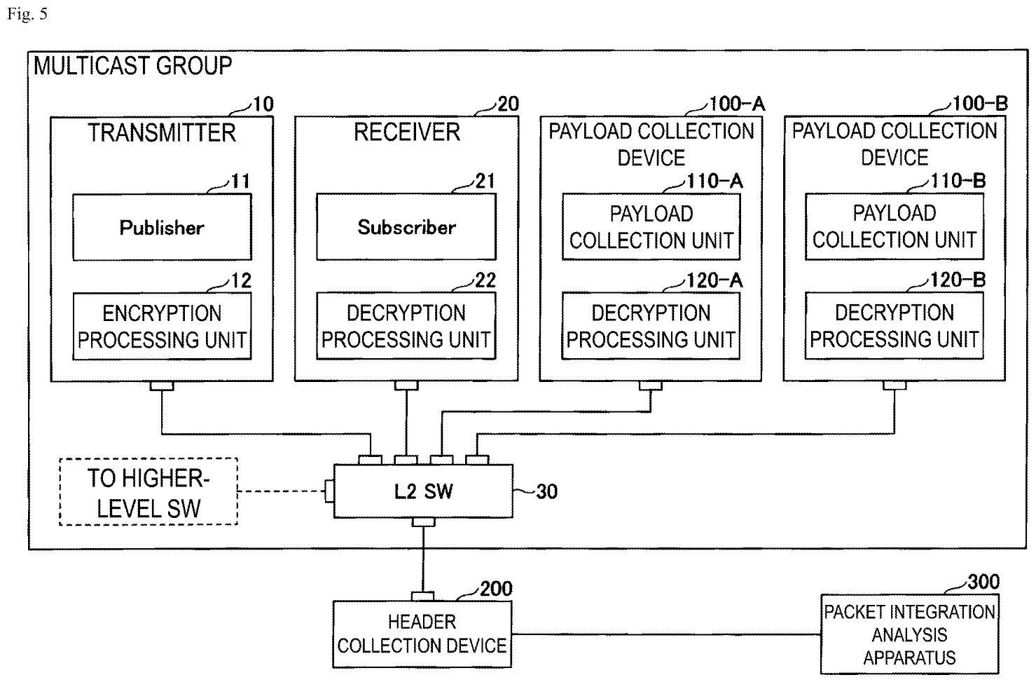

FIG. 5 illustrates a configuration example in one multicast group. The other multicast groups have the similar configuration.

As illustrated in FIG. 5, the multicast group includes a transmitter 10, a receiver 20, a payload collection device 100-A, a payload collection device 100-B, and an L2SW 30 (layer 2 switch 30). Each device is connected to the L2SW 30 as illustrated in FIG. 5. The payload collection device 100-A and the payload collection device 100-B have the same configuration, and thus, will be described as a “packet collection device 100” when description will be made without distinguishing the payload collection device 100-A and the payload collection device 100-B from each other. Only one payload collection device 100 may be provided, or three or more payload collection devices may be provided.

In the present embodiment, the transmitter 10 and the receiver 20 transmit and receive messages by using a Publish/Subscribe model (referred to as a Pub/Sub model below and may be referred to as a publish-purchase model). In the Pub/Sub model in the present embodiment, the transmitter 10 corresponds to a Publisher, and the receiver 20 corresponds to a Subscriber. In the present embodiment, it is assumed that a data distribution service (DDS), which is one of the systems of the Pub/Sub model, is used. The present disclosure is not limited thereto.

The transmitter 10 is, for example, a sensor. The receiver 20 is, for example, a device that analyzes sensor data or a control device that controls in accordance with the sensor data.

As a basic operation, the receiver 20 (Subscriber) applies for message transmission (message subscription) for a desired topic to the transmitter 10 (Publisher), and the transmitter 10 (Publisher) transmits the message of the topic to the receiver 20 (Subscriber). The transmitted message includes a topic name and a value.

In the present embodiment, the message is transmitted from the transmitter 10 to the receiver 20 as a payload of a packet having a header. In the present embodiment, the message (the payload of the packet) is encrypted in the transmitter 10 and decrypted in the receiver 20.

In the present embodiment, it is assumed that the payload collection device 100 is not a device exclusively provided for payload collection but is a device in which a function for payload collection is added to a device functioning as a receiver. The payload collection device 100 may be a device exclusively provided for payload collection.

A packet transmitted from the transmitter 10 is transmitted to each of the receiver 20 and the packet collection device 100 in the same multicast group, and each of the receiver 20 and the packet collection device 100 receives the packet. Specifically, the packet transmitted from the transmitter 10 reaches the L2SW 30, and the L2SW 30 outputs a packet from the respective ports to which the receiver 20 and the packet collection device 100 in the same multicast group are connected.

In addition, unicast communication is also performed between the transmitter 10 and the receiver 20/packet collection device 100. In the unicast communication, a packet transmitted from the transmitter 10 first reaches the L2SW 30, and the L2SW 30 transmits the packet from a port to which the destination device is connected. In the unicast communication, a packet transmitted from the receiver 20/packet collection device 100 first reaches the L2SW 30, and the L2SW 30 transmits the packet from a port to which the destination device is connected.

The L2SW 30 transmits the received packet to the destination, and copies (mirrors) the transmitted and received packet and transmits the packet to the header collection device 200.

As illustrated in FIG. 5, the transmitter 10 includes a Publisher 11 and an encryption processing unit 12. The Publisher 11 is a functional unit that generates and transmits a message for a topic in response to a subscription application for the topic.

The encryption processing unit 12 is a functional unit that encrypts the message received from the Publisher 11, generates a packet having the encrypted message as a payload, and transmits the packet. The encryption processing unit 12 may be referred to as “security Pub/Sub middleware”.

The receiver 20 includes a Subscriber 21 and a decryption processing unit 22. The Subscriber 21 is a functional unit that makes a subscription application for a certain topic to the Publisher 11 and receives a message regarding the topic from the Publisher 11.

The decryption processing unit 22 is a functional unit that decrypts the encrypted payload in the packet received from the transmitter 10 and transmits the decrypted payload (message) to the Subscriber 21. The decryption processing unit 22 may be referred to as “security Pub/Sub middleware”.

The payload collection device 100 includes a payload collection unit 110 and a decryption processing unit 120. The payload collection unit 110 has a function of the above-described Subscriber 21 and a function related to payload collection. A configuration (block diagram) and an operation of the function related to payload collection will be described later. The decryption processing unit 120 has a function similar to that of the decryption processing unit 22 described above.

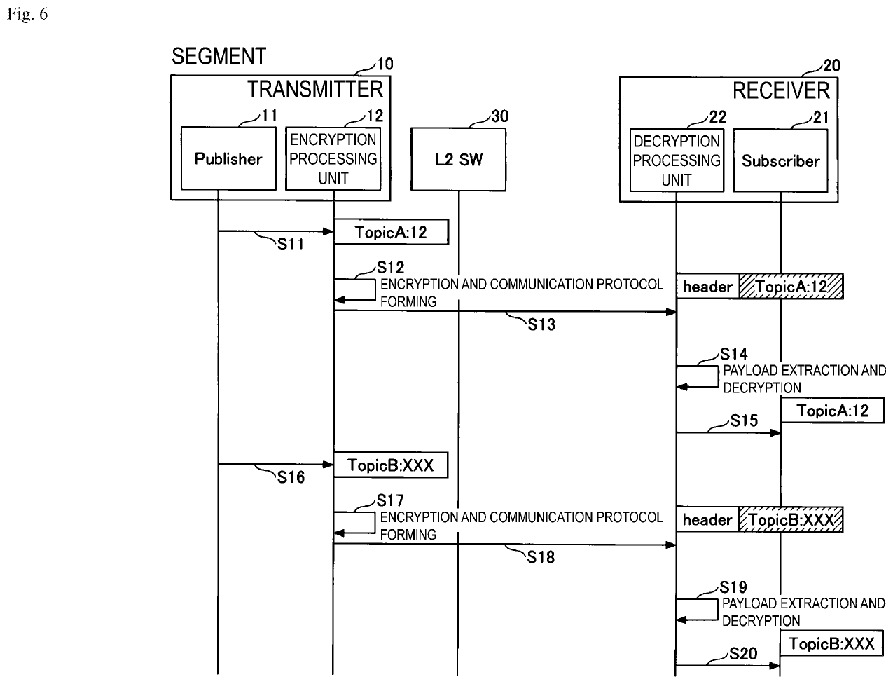

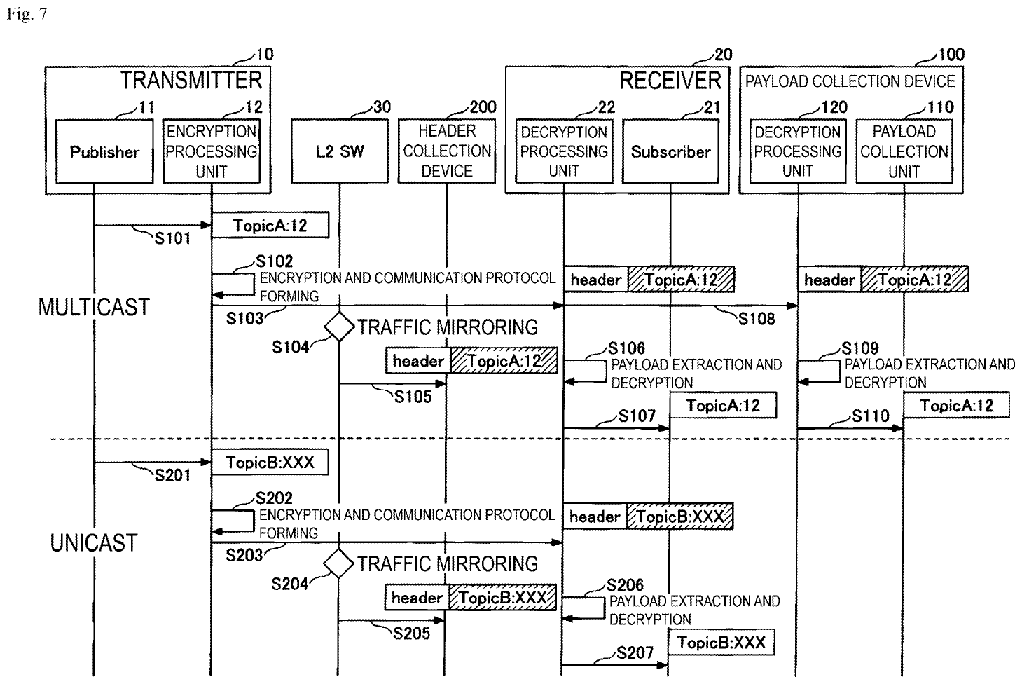

Flow of Packet Next, an example of a flow of a packet in the present embodiment will be described with reference to FIGS. 6 and 7.

FIG. 6 is a diagram illustrating a flow of a packet in Pub/Sub communication in a multicast group (in a segment).

In S11, the Publisher 11 in the transmitter 10 transmits a message (Topic A:12) to the encryption processing unit 12. In S12, the encryption processing unit 12 encrypts the message and generates a packet by attaching a header to the encrypted message (payload). In S13, the decryption processing unit 12 transmits the packet.

The decryption processing unit 22 in the receiver 20 receives the packet. In S14, the decryption processing unit 22 extracts the encrypted payload from the packet and decrypts the encrypted payload. In S15, the decryption processing unit 12 transmits a message which is a decoded payload to the Subscriber 22.

In S16 to S20, processes similar to those in S11 to S15 are executed on a message of a topic B.

FIG. 7 is a diagram illustrating the flow of the packet in the present embodiment. First, multicast communication will be described.

In S101, the Publisher 11 in the transmitter 10 transmits the message (Topic A:12) to the encryption processing unit 12. In S102, the encryption processing unit 12 encrypts the message and generates the packet by attaching a header to the encrypted message (payload). In S103, the encryption processing unit 12 transmits the packet.

The transmitted packet reaches each of the receiver 20 and the packet collection device 100 (S103 and S108), and payload extraction and decryption are performed in each of the receiver 20 and the packet collection device 100 (S106, S107, S109, and S110).

In S104 and S105, the L2SW 30 performs monitoring on a packet and transmits the packet to the header collection device 200. The header collection device 200 receives the packet.

Next, unicast communication will be described. The unicast communication is performed, for example, for mutual vital monitoring between the Publisher and the Subscriber.

In S201, the Publisher 11 in the transmitter 10 transmits the message (Topic B: xxx) to the encryption processing unit 12. In S202, the encryption processing unit 12 encrypts the message and generates the packet by attaching a header to the encrypted message (payload). In S203, the encryption processing unit 12 transmits the packet.

The transmitted packet is transmitted only to the receiver 20 that is a unicast destination (S203), and payload extraction and decryption are performed in the receiver 20 (S206 and S207). When the unicast destination is the payload collection device 100, the payload collection device 100 collects the payload by performing processing similar to the processing in the receiver 20.

In S204 and S205, the L2SW 30 performs mirroring on a packet and transmits the packet to the header collection device 200. The header collection device 200 receives the packet.

Regarding Encryption Communication

The encryption in the present embodiment is based on a common-key encryption scheme. The present disclosure is not limited to the common-key encryption scheme, and an encryption scheme other than the common-key encryption scheme may be used.

The unit of generating a common key in the present embodiment is not limited to a specific unit and may be any unit. A method, a frequency, and the like of key exchange are not limited to specific ones, and may be any method, frequency, and the like.

For example, regarding the key exchange, any one of “one multicast group has one common key”, “one common key is provided for one Topic, and “one common key is provided for one pair of nodes” may be used.

For example, a specific example of multicast in a case where “one common key is provided for one pair of nodes” is as follows.

For example, when there are three receivers, the transmitter generates and transmits a packet in a format of [header: {encrypted payload for receiver 1, encrypted payload for receiver 2, encrypted payload for receiver 3}]. If the receiver 3 is the payload collection device 100, the payload collection device 100 can acquire the contents of the payload by decrypting only the encrypted payload for the receiver 3.

Configurations and operations of the header collection device 200, the payload collection unit 110 in the payload collection device 100, and the packet integration analysis apparatus 300 will be described below.

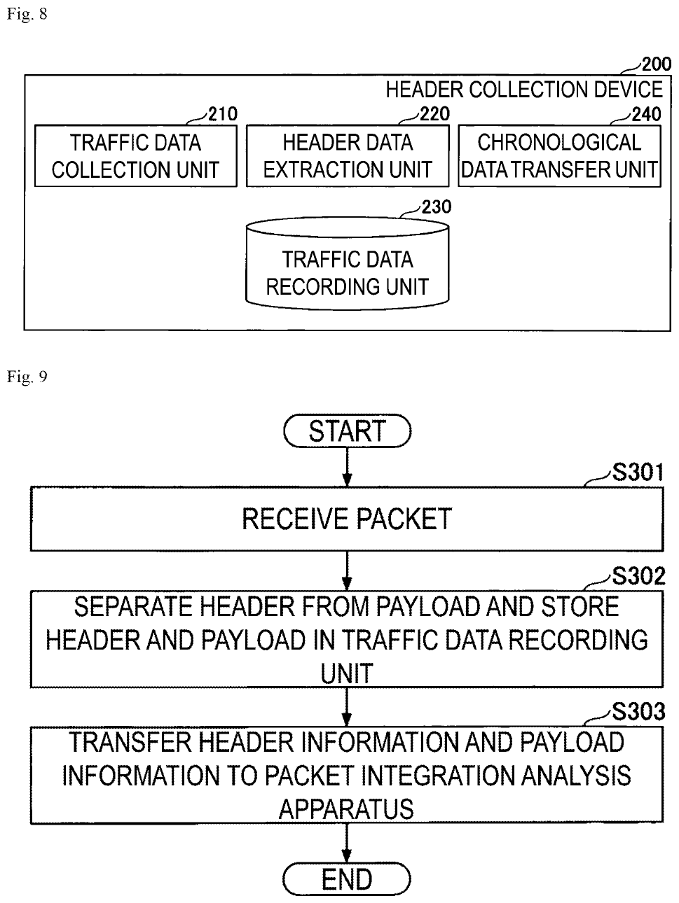

Header Collection Device 200 FIG. 8 is a configuration diagram of the header collection device 200. As illustrated in FIG. 8, the header collection device 200 includes a traffic data collection unit 210, a header data extraction unit 220, a traffic data recording unit 230, and a chronological data transfer unit 240.

The operation of each unit will be described in accordance with the procedure of the flowchart in FIG. 9. In S301, the traffic data collection unit 210 receives packets transmitted from the L2SW 30 to the header collection device 200 in chronological order and transfers the packets to the header data extraction unit 220 as needed. As a method of the traffic data collection unit 210 receiving the packets, any method may be provided. For example, there is a method using tcpdump, wireshark, socket programming, or the like.

In the present embodiment, since the header collection device 200 collects packets without using the dedicated device that decrypts as illustrated in FIG. 3, it is possible to collect packets in chronological order with little influence on a difference in traffic amount for each multicast group and the like.

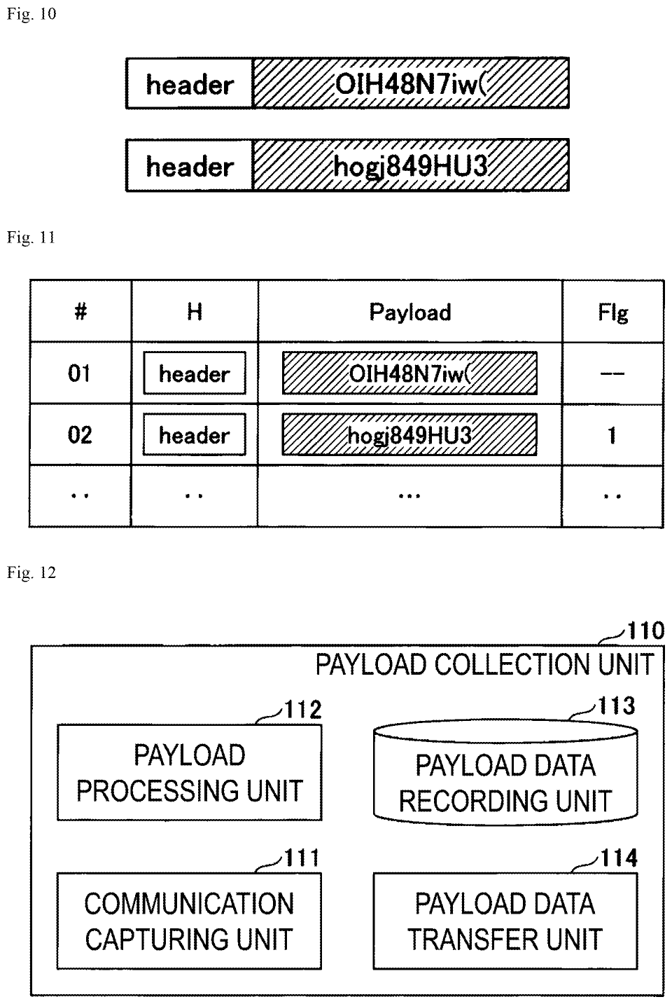

FIG. 10 illustrates an example of a packet received by the traffic data collection unit 210. As illustrated in FIG. 10, each packet has a header and an encrypted payload.

In S302 in FIG. 9, the header data extraction unit 220 separates the header and the payload in each packet from each other, and stores header information and payload information obtained by the separation in the traffic data recording unit 230 in an order of receiving the packets. At this time, when the unicast communication is identified from the header information, the header data extraction unit 220 stores the header information and the payload information related to the unicast communication together with Flg data, in the traffic data recording unit 230. FIG. 11 illustrates an example of information (table) stored in the traffic data recording unit 230.

In S303 in FIG. 9, the chronological data transfer unit 240 extracts header information (H) and payload information (Payload) about the communication stored in the traffic data recording unit 230 and transfers the extracted header information (H) and payload information (Payload) in chronological order to the packet integration analysis apparatus 300.

At this time, the chronological data transfer unit 240 also adds an ID (domain ID or the like in DDS) of the multicast group to the header information (H) and the payload information (Payload) and performs transmission. Regarding a transfer form, a communication path, a protocol, a file format, and the like are not limited to specific ones, and any may be used.

Payload Collection Unit 110 FIG. 12 is a configuration diagram of the payload collection unit 110. As illustrated in FIG. 12, the payload collection unit 110 includes a communication capturing unit 111, a payload processing unit 112, a payload data recording unit 113, and a payload data transfer unit 114.

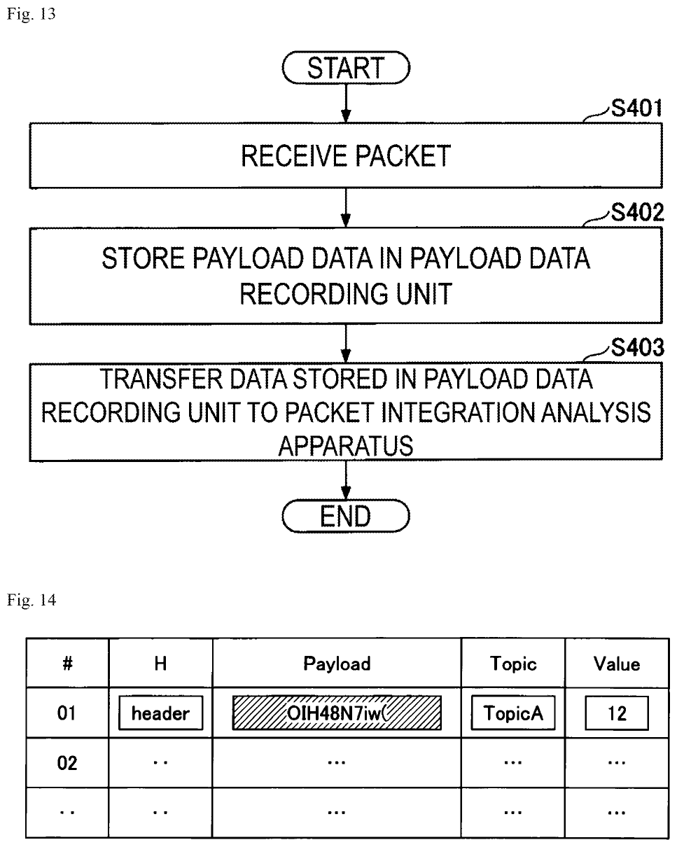

The operation of each unit will be described in accordance with the procedure of the flowchart in FIG. 13. In S401, the communication capturing unit 111 receives a packet and stores the received packet in the payload data recording unit 113 as needed. The packet received here is similar to the packet illustrated in FIG. 10. Regarding a method of receiving the packet, any method may be used similarly to the traffic data collection unit 210.

In S402 in FIG. 13, the payload processing unit 112 collects a Topic name and Value from the payload decrypted by using the decryption processing unit 120 with respect to the packet received by the communication capturing unit 111. Then, the payload processing unit 112 stores the Topic name and Value in the payload data recording unit 113 in association with the header information and the payload information of the packet. FIG. 14 illustrates an example of a table stored in the payload data recording unit 113.

In S403 in FIG. 13, the payload data transfer unit 114 extracts the header information (H), the payload information (Payload), and topic information (Topic) and value information (Value) obtained by decrypting the payload information, for each communication stored in the payload data recording unit 113. Then, the payload data transfer unit 114 transfers the extracted pieces of information to the packet integration analysis apparatus 300.

At this time, the payload data transfer unit 114 also adds the ID (domain ID or the like in DDS) of the multicast group to the above information and performs transmission. Regarding a transfer form, any method may be used similarly to the chronological data transfer unit 240. The information to be transferred may include unicast data for the payload collection unit 110.

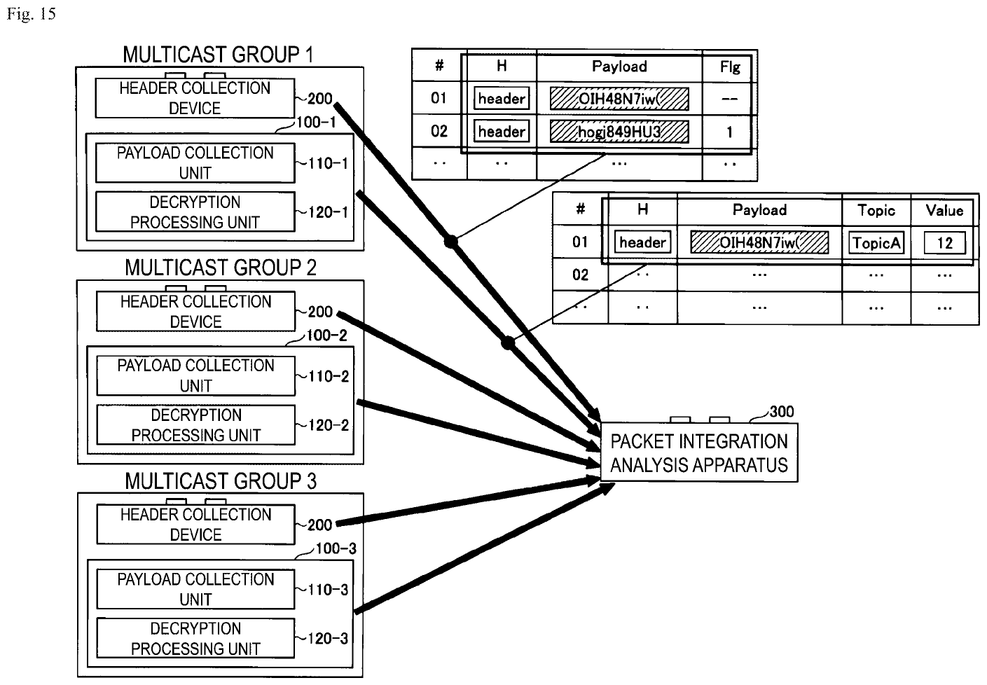

As illustrated in FIG. 15, the header information and the payload information of each multicast group are transmitted from the header collection device 200 to the packet integration analysis apparatus 300, and the header information, the payload information, Topic, and Value are transmitted to the packet integration analysis apparatus 300 from the payload collection unit 110 in each multicast group.

Packet Integration Analysis Apparatus 300

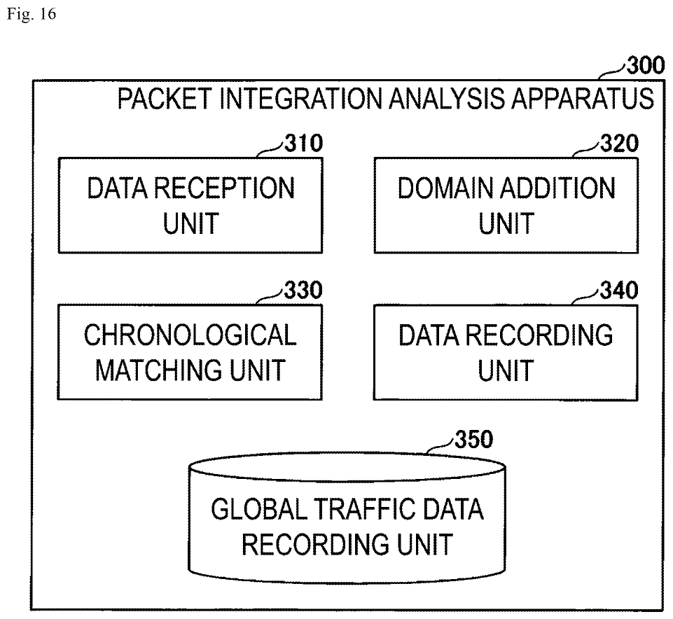

FIG. 16 is a configuration diagram of the packet integration analysis apparatus 300. As illustrated in FIG. 16, the packet integration analysis apparatus 300 includes a data reception unit 310, a domain symbol addition unit 320, a time-series matching unit 330, a data recording unit 340, and a global traffic data recording unit 350.

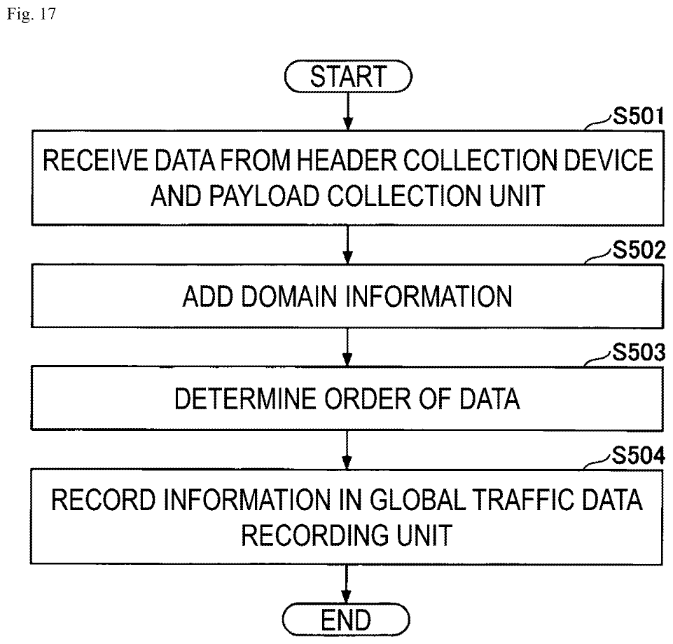

The operation of each unit will be described in accordance with the procedure of the flowchart in FIG. 17. In S501, the data reception unit 310 receives data transferred from each of the header collection 200 and the payload collection unit 110 and transfers the received data to the domain symbol addition unit 320 as needed. Regarding a method of receiving the data, any method may be used similarly to the traffic data collection unit 210.

In S502, the domain symbol addition unit 320 adds domain information as information for identifying from which multicast group the data has come, to the information transferred from the data reception unit 310. The domain information to be added may be extracted from the header information (multicast address or the like) or may be set to a different value for each multicast group to be collected in advance.

In S503, the time-series matching unit 330 determines the order of pieces of data (the order in chronological order) in accordance with the order of the pieces of data collected from the header collection device 200 in chronological order and transfers the obtained result to the data recording unit 340.

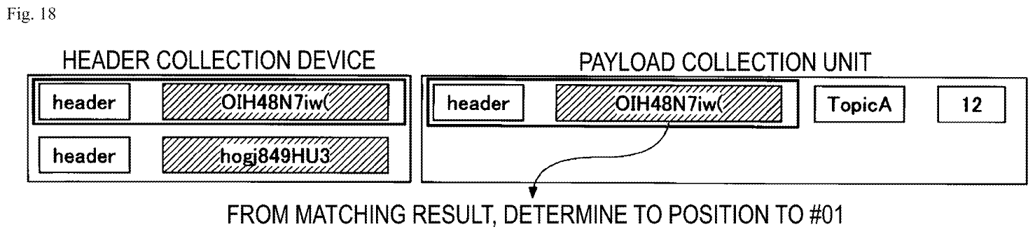

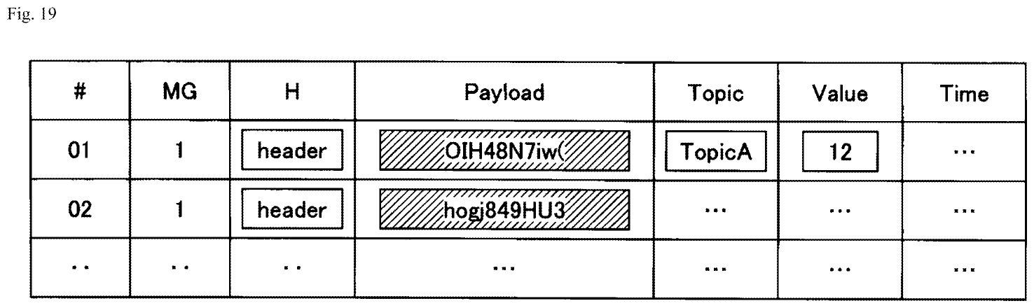

Since there is unicast communication that does not reach the payload collection device 100 and communication such as NTP and DNS, which is not processed by the payload processing unit even though reaching the payload collection device 100, the total amount of the pieces of data collected by the header collection device 200 is larger than the total amount of the pieces of data collected by the payload collection unit 110. The time-series matching unit 330 collates H and Payload of the header collection device 200 with the payload collection device 100 as unique data and determines the order of data. FIG. 18 illustrates an image of order determination processing.

In the example in FIG. 18, since the illustrated header and payload collected by the payload collection unit 110 coincide with the first header and payload collected by the header collection device 200, the illustrated header, payload, topic, and value collected by the payload collection unit 110 can be determined to be the first data in chronological order.

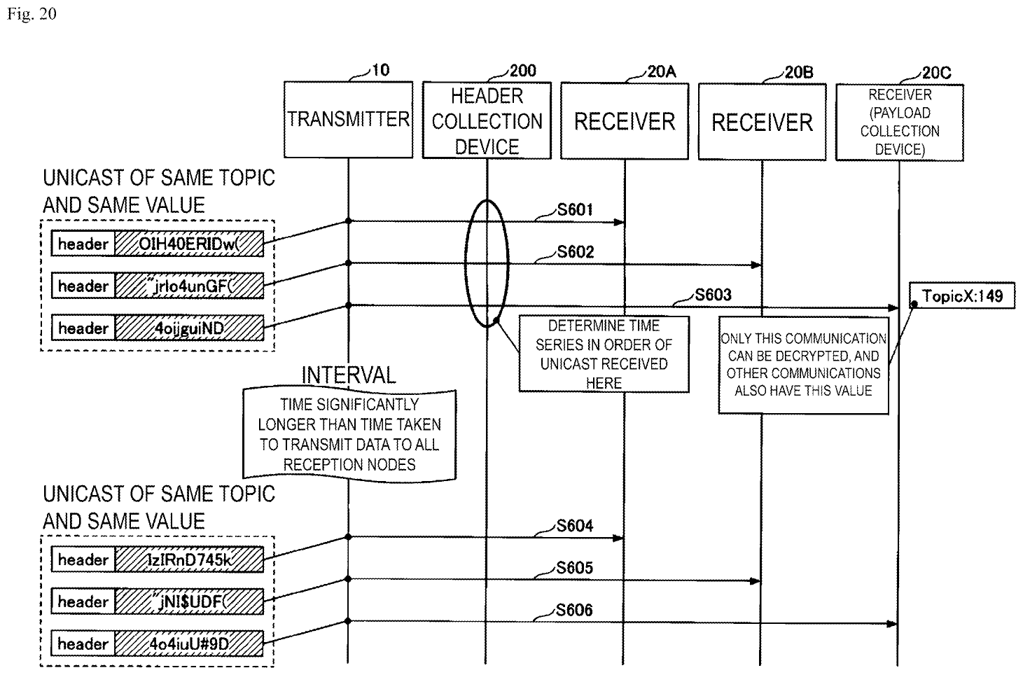

In S504, the data recording unit 340 records the information transferred from the time-series matching unit 330 in the global traffic data recording unit 350. FIG. 19 illustrates an image of information recorded in the global traffic data recording unit 350.

Regarding Unicast Communication

The configuration and processing in the present embodiment have been described assuming Pub/Sub communication using multicast for Topic Value as an example. The technique according to the present embodiment is not limited to multicast communication and can also be applied to Pub/Sub communication using unicast communication. Specific reasons are as follows.

As a mechanism of Pub/Sub communication according to the present embodiment, there are a plurality of receivers (Subscribers), and even if packets are transmitted to the respective receivers using different encryption keys, the contents of Topic to be transmitted at the same timing are the same value.

Thus, if one of the plurality of receivers is the payload collection device, the data obtained by the payload collection device can be regarded as the same group as the group of the unicast at the time close to the unicast to the other receivers.

FIG. 20 illustrates an example of unicast communication. As illustrated in FIG. 20, in S601 to S603 (the same is applied to S604 to S606), a unicast packet is transmitted from the transmitter 10 to each of receivers 20A to 20C. Topic and Value constituting the payload of each packet are the same.

The header collection device 200 receives the packets in S601 to S603 and can determine the time series in the order of reception here. That is, the time series can be determined by setting the packets received in S604 to 5606 next to the packets received in S601 to S603.

In the example in FIG. 20, the receiver 20C functions as the payload collection device, and Topic and Value decrypted by the receiver 20C are collected. Topic and Value are collected only by the receiver 20C among the communication of the receivers 20A to 20C, but the communication of the receivers 20A and 20B can also be regarded as having Topic and Value by the above-described Pub/Sub communication mechanism.

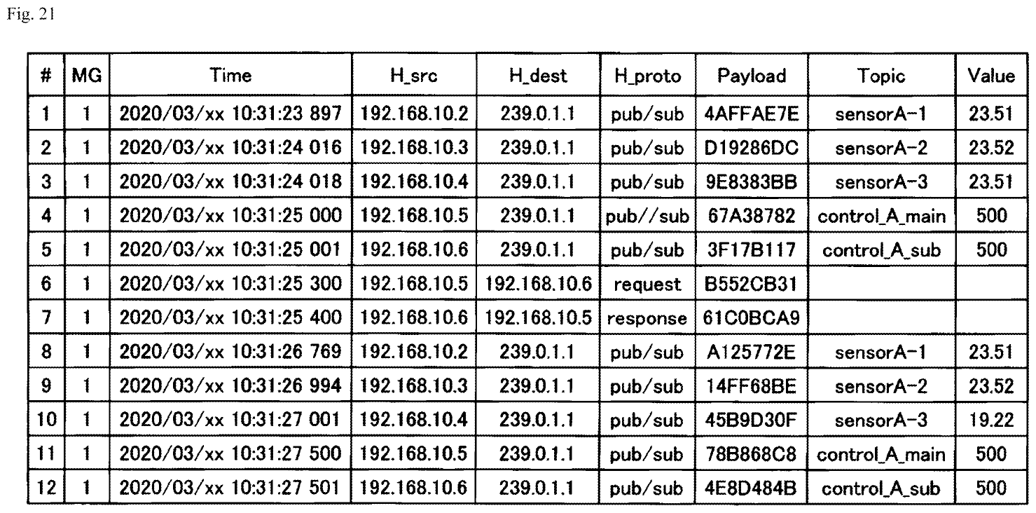

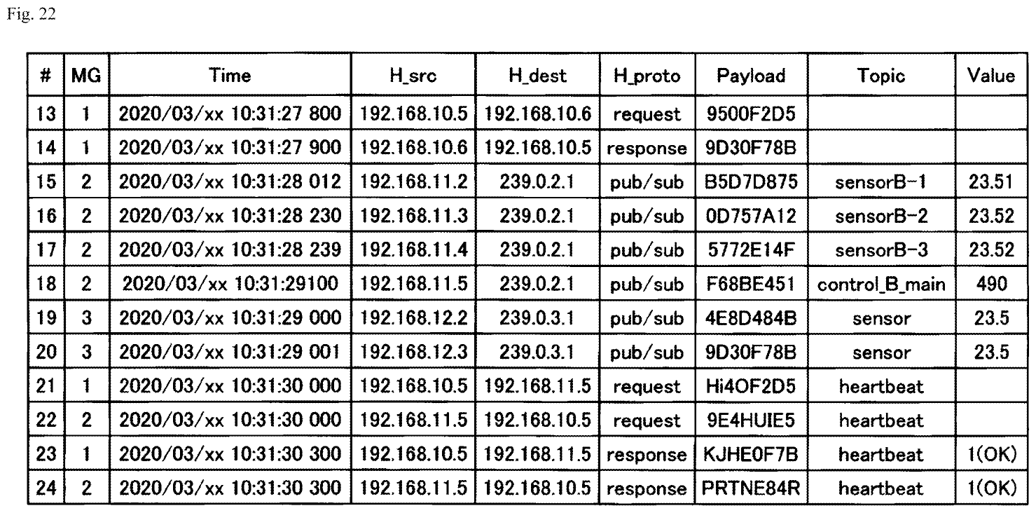

Example of Collected Information FIGS. 21 and 22 illustrate an example of pieces of data stored in the global traffic data recording unit 350 in the packet integration analysis apparatus 300. In the example illustrated in FIGS. 21 and 22, MG indicates a multicast group, Time indicates a time (for example, a time point at which the header collection device 200 acquires a packet), H_src indicates a transmission source address, H_dest indicates a destination address, and H proto indicates a protocol.

As illustrated in FIGS. 21 and 22, pieces of data are arranged in chronological order (order of time passage). Thus, for example, it is possible to detect that there is an abnormality in data of #10. That is, in #1 to #3, pieces of data of sensors A-1 to A-3 are continuous, and the values are 23.51 and 23.52. In pieces of data of the sensors A-1 to A-3 in subsequent #8 to #10, the first two values are 23.51 or 23.52, and the value of the data of #10 can also be estimated to be 23.51 or 23.52, but is actually 19.22. Thus, it can be determined that there is an abnormality.

As indicated by “control_A_main” and “control_A_sub” in #11 and #12, it is estimated that pieces of data of main and sub are acquired substantially simultaneously for control Topic. As indicated in #18 and before and after #18, “control B sub” for “control B main” is not obtained. Thus, it can be determined that there is an abnormality. In a case where the technique of the present disclosure is not used, there is a possibility that only “control B main” is obtained and then “control B sub” is obtained with a delay. Thus, abnormality detection of “there is no “control B sub” is delayed. That is, the technique of the present disclosure allows for quick abnormality detection. In addition, as indicated in #21 to #24, it is possible to align communication across multicast groups in chronological order.

### Hardware Configuration Example

All of the payload collection device 100, the header collection device 200, and the packet integration analysis apparatus 300 in the present embodiment can be achieved, for example, by causing a computer to execute a program describing processing contents described in the present embodiment.

The above program can be stored or distributed with the program recorded on a computer readable recording medium (such as a portable memory). In addition, the above program can also be provided through a network, such as the Internet or e-mail.

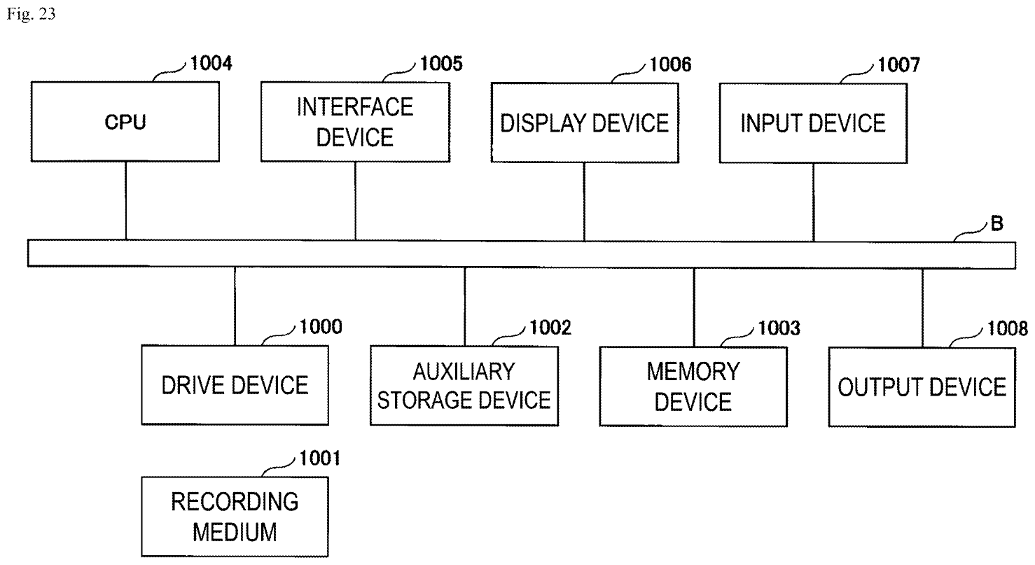

FIG. 23 is a diagram illustrating an example of the hardware configuration of the above computer. In FIG. 23, the computer includes a drive device 1000, an auxiliary storage device 1002, a memory device 1003, a CPU 1004, an interface device 1005, a display device 1006, an input device 1007, an output device 1008, and the like, which are connected to one another through a bus BS.

A program for executing processing in the computer is provided by a recording medium 1001 such as, for example, a CD-ROM or a memory card. When the recording medium 1001 having a program stored therein is set in the drive device 1000, the program is installed from the recording medium 1001 through the drive device 1000 to the auxiliary storage device 1002. However, the program does not necessarily have to be installed from the recording medium 1001 and may be downloaded from another computer through a network. The auxiliary storage device 1002 stores the installed program, and stores necessary files, data, and the like.

In response to an activation instruction of the program, the memory device 1003 reads out the program from the auxiliary storage device 1002 and stores the program. The CPU 1004 implements functions related to the payload collection device 100, the header collection device 200, the packet integration analysis apparatus 300, and the like in accordance with the program stored in the memory device 1003. The interface device 1005 is used as an interface for connection to a network. The display device 1006 displays a graphical user interface (GUI) or the like based on the program. The input device 1007 includes a keyboard, a mouse, a button, a touch panel, or the like, and is used for inputting various operation instructions. The output device 1008 outputs the calculation result.

### Effects of Embodiment

The technique according to the present embodiment enables efficient data collection for analyzing a plurality of pieces of decrypted data in chronological order in the communication system in which encrypted communication is performed.

In addition, it is not necessary to purchase a dedicated device for undertaking the abnormality detection processing as in a packet collection system assumed in a case where the present disclosure is not used. In addition, since the encryption/decryption key is automatically shared between the transmitter and the receiver, the cost of key setting or the like performed on the dedicated device is also unnecessary. Furthermore, since there is no hardware constraint, there is also an effect that a redundant configuration is easily taken even if the processing load on packet collection increases.

### Conclusion of Embodiment

This description describes at least the packet collection system, the packet integration analysis apparatus, the packet collection method, and the program in the following items.

### [Item 1]

A packet collection system for collecting a packet for abnormality detection in a communication system including one or more segments in which a packet having an encrypted payload is transmitted and received, the packet collection system including:
a header collection device that collects packets transmitted and received in the communication system from an individual segment of the one or more segments in chronological order and stores pieces of header information and payload information of the packets collected;
a payload collection device provided in the individual segment in the communication system, and configured to decrypt the payload information in the packet received in the individual segment and store decrypted payload information along with the header information and the payload information of the packet; and
a packet integration analysis apparatus configured to acquire and store the header information, the payload information, and the decrypted payload information aligned in chronological order by matching the header information and the payload information in chronological order received from the header collection device, with the header information, the payload information, and the decrypted payload information received from the payload collection device.

### [Item 2]

The packet collection system described in Item 1, in which each of the one or more segments is a multicast group, communication by a publish-subscribe model is performed between a transmitter serving as a publisher and a receiver serving as a subscriber, in each multicast group, and the payload collection device is one of a plurality of the receiver serving as the subscriber.

### [Item 3]

The packet collection system described in Item 1 or 2, in which the packet integration analysis apparatus adds information indicating a corresponding segment to the header information, the payload information, and the decrypted payload information aligned in chronological order, and stores the header information, the payload information, and the decrypted payload information with the information indicating a corresponding segment added.

### [Item 4]

A packet integration analysis apparatus to be used in a communication system including one or more segments in which a packet having an encrypted payload is transmitted and received, the packet integration analysis apparatus including:
a data reception unit that receives header information and payload information in chronological order from a header collection device and receives header information, payload information, and decrypted payload information from a payload collection device provided in an individual segment of the one or more segments, the header collection device collecting, in chronological order, the packet transmitted and received in the communication system;
a chronological matching unit that acquires header information, payload information, and decrypted payload information aligned in chronological order by matching the header information and the payload information in chronological order received from the header collection device with the header information, the payload information, and the decrypted payload information received from the payload collection device; and a traffic data recording unit that stores the header information, the payload information, and the decrypted payload information aligned in chronological order.

### [Item 5]

A packet collection method performed by a packet collection system for collecting a packet for abnormality detection in a communication system including one or more segments in which a packet having an encrypted payload is transmitted and received, the packet collection method including:
by a header collection device, collecting the packet transmitted and received in the communication system from an individual segment of the one or more segments in chronological order and store header information and payload information of the packet collected; by a payload collection device provided in the individual segment in the communication system, decrypting the payload information in the packet received in the individual segment and storing decrypted payload information along with the header information and the payload information of the packet received; and
by a packet integration analysis apparatus, acquiring and storing the header information, the payload information, and the decrypted payload information aligned in chronological order by matching the header information and the payload information in chronological order received from the header collection device with the header information, the payload information, and the decrypted payload information received from the payload collection device.

### [Item 6]

A program causing a computer to operate as an individual unit in the packet integration analysis apparatus described in Item 4.

Although the present embodiment has been described above, the present disclosure is not limited to such a specific embodiment and can be modified and changed variously without departing from the scope of the present disclosure described in the appended claims.

### REFERENCE SIGNS LIST

5, 6, 15, 25, 30, 35 SW
7 Integrated abnormality detection device
14, 24, 34 Dedicated device
10, 17, 27, 31 Transmitter
18, 19, 20, 28, 29, 32, 33 Receiver
11 Publisher
12 Encryption processing unit
21 Subscriber
22, 120 Decryption processing unit
100 Payload collection device
110 Payload collection unit
111 Communication capturing unit
112 Payload processing unit
113 Payload data recording unit
114 Payload data transfer unit
200 Header collection device
210 Traffic data collection unit
220 Header data extraction unit
230 Traffic data recording unit
240 Chronological data transfer unit
300 Packet integration analysis apparatus
310 Data reception unit
320 Domain symbol addition unit
330 Chronological matching unit
340 Data recording unit
350 Global traffic data recording unit
1000 Drive device
1001 Recording medium
1002 Auxiliary storage device
1003 Memory device
1004 CPU
1005 Interface device
1006 Display device
1007 Input device
1008 Output device

1. A packet collection system for collecting a packet for abnormality detection in a communication system including one or more segments in which a packet having an encrypted payload is transmitted and received, the packet collection system comprising:
a header collection device including a memory, and a processor configured to collect the packet transmitted and received in the communication system from an individual segment of the one or more segments in chronological order and store header information and payload information of the packet collected;
a payload collection device provided in the individual segment in the communication system and including a memory, and a processor configured to decrypt the payload information in the packet received in the individual segment and store decrypted payload information along with the header information and the payload information of the packet; and
a packet integration analysis apparatus including a memory, and a processor configured to acquire and store the header information, the payload information, and the decrypted payload information aligned in chronological order by matching the header information and the payload information in chronological order received from the header collection device with the header information, the payload information, and the decrypted payload information received from the payload collection device.

2. The packet collection system according to claim 1, wherein
each of the one or more segments is a multicast group, communication by a publish-subscribe model is performed between a transmitter serving as a publisher and a receiver serving as a subscriber in each multicast group, and the payload collection device is one of a plurality of receivers serving as the subscriber.

3. The packet collection system according to claim 1, wherein
the packet integration analysis apparatus adds information indicating a corresponding segment to the header information, the payload information, and the decrypted payload information aligned in chronological order, and stores the header information, the payload information, and the decrypted payload information with the information indicating a corresponding segment added.

4. A packet integration analysis apparatus to be used in a communication system including one or more segments in which a packet having an encrypted payload is transmitted and received, the packet integration analysis apparatus comprising:
a processor; and
a memory containing instructions that cause the processor to execute
receiving header information and payload information in chronological order from a header collection device and receive header information, payload information, and decrypted payload information from a payload collection device provided in an individual segment of the one or more segments, the header collection device being configured to collect, in chronological order, the packet transmitted and received in the communication system;
acquiring header information, payload information, and decrypted payload information aligned in chronological order by matching the header information and the payload information in chronological order received from the header collection device with the header information, the payload information, and the decrypted payload information received from the payload collection device; and
storing the header information, the payload information, and the decrypted payload information aligned in chronological order.

5. A packet collection method performed by a packet collection system for collecting a packet for abnormality detection in a communication system including one or more segments in which a packet having an encrypted payload is transmitted and received, the packet collection method comprising:
by a header collection device including a memory and a processor, collecting the packet transmitted and received in the communication system from an individual segment of the one or more segments in chronological order and storing header information and payload information of the packet collected;
by a payload collection device provided in the individual segment in the communication system and including a memory and a processor, decrypting the payload information in the packet received in the individual segment and storing decrypted payload information along with the header information and the payload information of the packet received; and
by a packet integration analysis apparatus including a memory and a processor, acquiring and storing the header information, the payload information, and the decrypted payload information aligned in chronological order by matching the header information and the payload information in chronological order received from the header collection device with the header information, the payload information, and the decrypted payload information received from the payload collection device.

6. A non-transitory computer-readable recording medium having computer-readable instructions stored thereon, which when executed, cause a computer including a memory and a processor to operate as the packet integration analysis apparatus according to claim 4.
